(19) United States
(12) Patent Application Publication
(10) Pub. No.: US 2015/0201652 A1
(43) Pub. Date: Jul. 23, 2015

(54) EDIBLE TEMPERATURE SENSITIVE COMPOSITIONS FOR FOOD PRODUCTS INDICATIVE OF CONSUMPTION SAFETY

(71) Applicant: UNIVERSITY OF GUELPH, Guelph (CA)

(72) Inventors: Shai Barbut, Guelph (CA); Massimo Marcone, Guelph (CA); Sunan Wang, Guelph (CA)

(21) Appl. No.: 14/430,889

(22) PCT Filed: Sep. 24, 2013
(86) PCT No.: PCT/CA2013/000812

§ 371 Date: Mar. 24, 2015

Related U.S. Application Data
(60) Provisional application No. 61/704,735, filed on Sep. 24, 2012.

(51) Int. Cl. A23L 1/03; A23L 1/01

(52) U.S. Cl. CPC A23L 1/0315; A23L 1/01; A23V 2002/00

(57) ABSTRACT

An edible, solid-based, temperature-sensitive composition is for use in uncooked foods to indicate food safety from harmful pathogens. The composition has a sharp melting point such that it undergoes an irreversible and visible physical transition change at temperatures from about 60° C. to 80° C.

### FIELD OF INVENTION

The invention relates to edible temperature sensitive compositions used in food products to indicate food consumption safety. More specifically, the invention provides an edible temperature sensitive composition for incorporation into foods, prior to cooking, that upon a target temperature the composition visually and irreversibly changes to indicate that harmful food borne pathogens are inactivated and thus the food is safe for consumption. The invention further relates to foods comprising the composition and methods of making and using the composition.

### BACKGROUND OF THE INVENTION

Many foods require cooking to a constant endpoint temperature in order to be considered safe to eat. One of the main challenges faced by the food industry is to determine when this end point cooking temperature occurs for a variety of foods (herein referred to as “food products”) that may contain pathogens harmful for human consumption. Any variety of foods including meats (i.e. ground meat, steaks), vegetables (i.e. veggie burgers) and baked goods (i.e. breads, cupcakes, cakes, pancakese—goods containing raw eggs) may contain harmful pathogens and therefore it is important to ensure that foods are properly cooked and thus safe to consume.

In particular, it is desired to eliminate the ever increasing outbreaks of food-borne pathogens such as E. coli O157:H7, which are linked to the consumption of undercooked ground beef patties (Kiranmaryi, Krishnaiah, & Mallika, 2010). A proper cooking temperature significantly minimizes the problem and those stemming from other microbiological contaminates as well. An internal end point temperature of 71° C. has been recommended for properly cooking a product, such as ground beef patties, by various regulatory agencies including the Canadian Food Inspection Agency and the United States Department of Agriculture.

The two most common approaches employed by consumers to determine the “doneness” of food products such as cooked meat and baked goods include: a) visual observation (e.g. a color and texture) of the heated product; and b) the use of a thermometer to assure that a predetermined internal temperature has been achieved (e.g., 71° C. for hamburger patties). With respect to cooked meat, the documented phenomenon of “premature browning”, “persistent pink” and that of “color reversion”, create confusion and mistakes among consumers and chefs when trying to determine the “doneness” of meat by these stated methods (Aberle, Forrest, Gerrard, & Mills, 2001; Killinger, Hunt, Campbell, & Kropf, 2000; King & Whyte, 2006; Mancini, Kropf, Hunt, & Johnson, 2005; Seyfert, Mancini, & Hunt, 2004).

“Premature browning” is a phenomenon where meat will turn color (from pink to brown) even before 67° C. has been reached, due to a lower redox potential; i.e., producers and consumers have no control over this and can't tell how the meat will behave (King & Whyte, 2006). On top of this is a common problem of improper use of thermometers, which also presents a potential risk to consumers. Reported improper usage includes the occurrence of improper handling (e.g., not sticking the thermometer at the geometrical center of the food product; can be difficult in a thin hamburger patty), purchasing low quality/inexpensive dial thermometers (e.g., guaranteed accuracy within +/−2 C), operating poor function thermometers (e.g., dial thermometer will show results even after dropping on the floor), as well as calibration and cleaning problems (Lee, Hillers, McCurry, & Kang, 2004; McCurdy et al., 2005).

A number of commercial temperature indicators have been suggested and prototypes developed based on diffusion, enzymatic and polymer reaction approaches (Kerry, O'Grady, & Hogan, 2006). The diffusion-based approaches depend on diffusion of certain chemicals, which migrate into a matrix with a corresponding color change (Kerry, O'Grady, & Hogan, 2006). Enzymatic-based approaches refer to incorporating enzyme-substrate combinations into food systems, which respond to certain changes (e.g., temperature, pH), thereby triggering the activation of the enzyme to cleave the substrate, and provide a measurable response (Prodromidis, & Karayannis, 2002; Tsironi, Gogou, Velliou, Taoukis, 2008). On the other hand, polymer-based approaches rely on polymerisation reactions which lead to color changes that can be captured by specific optical detectors (Nuinetal, 2008). The above mentioned methods have limited commercial application due to their cost, complexity to perform and reliability (Kerry, O'Grady, & Hogan, 2006). Of the three approaches, none is able to strictly respond to or measure a temperature approximating 71° C. in the center of the product, which would be considered the minimum microbiological safety temperature for products such as cooked hamburgers and ground beef patties. In addition, these approaches are not consumer friendly and are not designed for home use type applications (i.e. are too complicated to preform).

Still other approaches have been developed that include heat triggered alterations in products. U.S. Pat. No. 6,403,131 discloses a device for indicating the temperature within a predetermined temperature range by heated food. U.S. Pat. No. 7,875,207 discloses thermo-mechanical devices comprising organic materials with variable melting properties. U.S. 2009/0269447 discloses heat-triggered colorants for altering the colour of a food. U.S. Pat. No. 6,607,744 discloses a non-specific composition comprising ingestible polydiacetylene homopolymers with transition temperatures of about −10° C. to 200° C. The polymers must be processed in various manners for a variety of indication applications that are not limited to food. Due to the potential health concerns, using above polymers and other materials may not suitable for food products in general.

It is therefore desirous to develop an edible composition that can readily be incorporated into a variety of food products that in a temperature dependent manner can reliably and irreversibly provide an indication of the doneness of foods that may contain harmful pathogens.

### SUMMARY OF THE INVENTION

The invention in aspects provides an edible temperature sensitive composition for use in a variety of food products to indicate when the food is appropriately cooked such that harmful food borne pathogens are inactivated. The composition is incorporated into a food product (that may contain a harmful pathogen) to provide a clear and irreversible identification of when the internal temperature of the food has reached a microbiologically safe cooking temperature during cooking of the food product. The compositions of the invention will help to improve the safety and quality of food products (i.e. benefit the well-being of the consumer) and also boost consumer's confidence and thereby enhance consumption and improve competitive advantage of the manufacturers who will include it in their products.

The edible temperature sensitive composition of the invention is a composition that is embedded in a food product that will be heat processed (i.e. cooked). During the cooking process the composition undergoes a clear and irreversible physical transition change (e.g., physical form change and/or a colour change) at a target temperature range of about 60° C. to 80° C. This clear and irreversible physical transition change indicates that any pathogens that may be present in the food that are detrimental to human health are essentially inactivated, i.e. killed as a result of the food product reaching a temperature that essentially kills the pathogen. As such the food product is suitable for safe human consumption.

According to an aspect of the invention is an edible temperature sensitive composition that irreversibly undergoes a clear and visible physical transition change within a sharp melting point that indicates the doneness of a food product in which it is contained.

According to another aspect of the invention is an edible temperature sensitive composition that irreversibly undergoes a clear and visible physical transition change within a sharp melting point that indicates that harmful pathogens are essentially inactivated in a food product in which it is contained.

According to an aspect of the invention is an edible temperature sensitive composition that irreversibly undergoes a clear and visible physical transition change within a temperature range of about 60° C. to about 80° C. that indicates the doneness of a food product in which it is contained.

According to another aspect of the invention is an edible temperature sensitive composition that irreversibly undergoes a clear and visible physical transition change within a temperature range of about 60° C. to about 80° C. that indicates that harmful pathogens are essentially inactivated in a food product in which it is contained.

According to another aspect of the invention is an edible temperature sensitive composition comprising:

lipid having a melt profile of about 60° C. to 80° C.;

optional temperature modifier; and

optional colour indicator,

wherein said composition undergoes a clear and visible physical transition change within a temperature range of about 60° C. to about 80° C. that indicates that harmful pathogens are essentially inactivated in a food product in which it is contained.

According to another aspect of the invention is an edible temperature sensitive composition comprising canola stearin and up to about 5% by weight lutein, wherein said composition undergoes a clear and visible physical transition change within a temperature range of about 60° C. to about 80° C. that indicates that harmful pathogens are essentially inactivated in a food product in which it is contained. In aspects, the composition further comprises up to about 10% by weight temperature modifier.

According to another aspect of the invention is an edible lipid based temperature sensitive composition that has a sharp melting point, the composition comprising lipid based discrete units that exhibit an irreversible and visible physical transition change at temperatures from about 60° C. to about 80° C.

According to another aspect of the invention is an edible temperature sensitive composition that has a sharp melting point, the composition comprising canola stearin discrete units that exhibit an irreversible and visible physical transition change at temperatures from about 60° C. to about 80° C. Temperature modifiers and colour indicators are further optional.

According to another aspect of the invention is an edible lipid based temperature sensitive composition that has a sharp melting point, the composition comprising discrete units comprising lipid, temperature modifiers, and/or colour indicators, wherein said discrete units exhibit an irreversible and visible physical transition change at temperatures from about 60° C. to about 80° C.

According to another aspect of the invention is a frozen edible lipid based temperature sensitive composition that has a sharp melting point, the composition comprising discrete units comprising lipid, temperature modifiers, and/or colour indicators, wherein said discrete units exhibit an irreversible and visible physical transition change at temperatures from about 60° C. to about 80° C. In aspects the discrete units comprise canola stearin.

According to another aspect of the invention is an edible temperature sensitive composition that has a sharp melting point, such that it undergoes an irreversible and visible physical transition change at temperatures from about 60° C. to 80° C., the composition comprising:

lipid having a melting point of from about 60° C. to about 80° C.;

temperature modifier; and

optional colour indicator.

According to another aspect of the invention is an edible temperature sensitive composition that has a sharp melting point, such that it undergoes an irreversible and visible physical transition change at temperatures from about 60° C. to 80° C., the composition comprising:

a mixture of lipids having a melting point of from about 65° C. to about 80° C.;

up to about 20% by weight temperature modifier; and

up to about 5% by weight colour indicator.

According to another aspect of the invention is an edible temperature sensitive composition that has a sharp melting point, such that it undergoes an irreversible and visible physical transition change at temperatures from about 60° C. to 80° C., the composition comprising:

a mixture of fatty acids each having a melting point of from about 65° C. to about 80° C.;

up to about 20% by weight temperature modifier; and

up to about 5% by weight colour indicator.

The invention in several aspects includes the use of the composition as described herein for insertion within a raw food product, in aspects, a hamburger patty that is either fresh or frozen. In other aspects a vegetable patty that is either fresh or frozen. In other aspects a fish patty that is fresh or frozen.

According to an aspect of the invention is an uncooked food product comprising an edible temperature sensitive composition that upon cooking and reaching a temperature range of about 60° C. to 80° C., the composition irreversibly undergoes a clear and visible physical transition change that indicates the doneness of a food product in which it is contained.

According to an aspect of the invention is an uncooked food product comprising an edible temperature sensitive composition that upon cooking and reaching a temperature range of about 60° C. to 80° C., the composition irreversibly undergoes a clear and visible physical transition change that indicates that harmful pathogens are essentially inactivated in the food product.

According to an aspect of the invention is an uncooked raw egg containing food product comprising an edible temperature sensitive composition that upon cooking and reaching a temperature range of about 60° C. to 80° C., the composition irreversibly undergoes a clear and visible physical transition change that indicates that harmful pathogens are essentially inactivated in the food product. In aspects the raw egg is a whole raw egg or component thereof such as the egg yolk or the egg white.

According to another aspect of the invention is a raw ground meat patty comprising an edible temperature sensitive composition that upon cooking and reaching a temperature range of about 60° C. to 80° C., the composition irreversibly undergoes a clear and visible physical transition change that indicates that harmful pathogens are essentially inactivated in the food product.

According to another aspect of the invention is a raw hamburger patty comprising an edible temperature sensitive composition comprising canola stearin and optionally a colour indicator that upon cooking and reaching a temperature range of about 65° C. to 75° C., the composition irreversibly undergoes a clear and visible physical transition change that indicates that E. coli O157:H7 is essentially inactivated in the food product.

According to another aspect of the invention is a raw veggie patty comprising an edible temperature sensitive composition that upon cooking and reaching a temperature range of about 60° C. to 80° C., the composition irreversibly undergoes a clear and visible physical transition change that indicates that harmful pathogens are essentially inactivated in the food product.

According to another aspect of the invention is raw ground meat patty, said patty comprising one or more discrete units of an edible lipid based temperature sensitive composition that has a sharp melting point, such that it undergoes an irreversible and visible physical transition change at temperatures from about 60° C. to 80° C. indicating that harmful pathogens are essentially inactivated.

According to another aspect of the invention is a frozen raw ground meat patty, said patty comprising one or more discrete units of an edible lipid based temperature sensitive composition that has a sharp melting point, such that it undergoes an irreversible and visible physical transition change at temperatures from about 60° C. to 80° C. upon cooking indicating that harmful pathogens are essentially inactivated.

According to another aspect of the invention is an uncooked vegetable, fish or meat patty comprising one or more discrete units of an edible temperature sensitive composition that upon cooking and reaching a temperature range of about 60° C. to 80° C., the composition comprising:

lipid having a melting point of from about 60° C. to about 80° C.;

about 1% to about 10% by weight temperature modifier; and

optionally about 0.1% to about 5% by weight colour indicator.

According to another aspect of the invention is a method to indicate the doneness of hamburger or veggie patty:

inserting into an uncooked hamburger or veggie patty one or more discrete units of a composition comprising an edible lipid based temperature sensitive composition;

applying a heat source to the hamburger or veggie patty; and

observing a clear and irreversible physical transition of said discrete units,

wherein said physical transition indicates that the internal temperature of the hamburger or veggie patty is about 65° C. to 75° C. indicating that any harmful pathogens are essentially inactivated.

According to another aspect of the invention is a method to indicate that a food product has been adequately cooked and is safe to consume, the method comprising;

to said food product incorporating an edible temperature sensitive composition that irreversibly undergoes a clear and visible physical transition change within a temperature range of about 60° C. to about 80° C. that indicates that harmful pathogens are essentially inactivated and therefore the food product is adequately cooked and safe to consume.

According to another aspect of the invention is a method of making an edible temperature sensitive composition, the method comprising:

to a lipid having a melt profile of about 60° C. to 80° C.; blending up to about 20% by weight temperature modifier and optionally 0.01% to 5% by weight colour indicator to form a homogeneously dispersed solution;

cooling the homogeneously dispersed solution; and

re-solidifying into discrete units.

According to another aspect of the invention is a method of making an edible temperature sensitive composition, the method comprising:

(a) blending a lipid having a melt profile of about 60° C. to 80° C. with about 1% to 20% by weight temperature modifier and optionally 0.01% to 5% by weight colour indicator at about room temperature;

(b) melting (a) just above the melting temperature to form a homogenously dispersed solution; and

(c) to form a homogeneously dispersed solution;
cooling the homogeneously dispersed solution; and
re-solidifying into discrete units.

In aspects of the method, the lipid is canola stearin.

In further aspects of the invention is the use of an edible temperature sensitive composition in a raw food product, the composition irreversibly undergoes a clear and visible physical transition change within a sharp melting point that indicates that harmful pathogens are essentially inactivated in a food product in which it is contained.

In further aspects of the invention is a raw hamburger comprising one or more discrete units comprised of an edible temperature sensitive lipid based composition comprising canola stearin, wherein said composition irreversibly undergoes a clear and visible physical transition change within a sharp melting point of about 69° C. to about 72° C. that indicates the doneness of the hamburger upon cooking. In aspects, reaching said sharp melting point indicates that E. coli O157:H7 is inactivated and the discrete units melt and form holes or indents in the hamburger where the units are located. In further aspects the composition further comprises a colour indicator that upon reaching said sharp melting point evokes a colour in the cooked hamburger to indicate that E. coli O157:H7 is inactivated.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1A, 1B and 1C show the results of a composition of canola stearin and lutein inserted into beef burgers and the formed holes when the internal temperature of the burgers reached 71° C.; and

FIG. 2 shows the fatty acids composition of the canola stearin determined by gas chromatography (GC).

FIG. 3 shows temperatures of the centers of NTF hamburgers containing the composition indicators of the invention;

FIG. 4 shows cooking time for NTF hamburgers containing the composition indicators of the invention;

FIG. 5 shows center temperatures of SF hamburgers containing composition indicators of the invention; and

FIG. 6 shows the cooking time for SF hamburgers containing the composition indicators of the invention.

### DETAILED DESCRIPTION OF THE INVENTION

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

A novel composition is described herein for use primarily in uncooked (i.e. raw) food products that may contain harmful pathogens to mammals (humans and animals) when ingested. The composition as provided is edible and temperature sensitive such that the composition exhibits a sharp melting point range of about 60° C. to about 80° C. This composition is used within a raw food product such that upon application of heat (i.e. any form of cooking), the composition undergoes a visible and irreversible physical phase change indicating that the food product has reached this range of temperature during cooking and that any harmful pathogens are essentially inactivated during the cooking process. As such, the composition is used to indicate when the food is adequately cooked (“doneness”) inactivating harmful pathogens and therefore it is safe to consume.

“Safety Doneness” as used herein is meant to define that the food product has reached a desired temperature. In an aspect, the temperature or level of doneness is one that substantially inactivates a harmful pathogen that may be contained therein to a level that is essentially safe for human consumption. For example, for hamburger patties, a temperature of 71° C. is recommended.

“Desired Degree Doneness”, in another aspect, the temperature or level of doneness is one that produces meat that is cooked to a desired consumption degree, e.g., rare, medium, or well done. For example, for steak, rare can be profiled as 52° C.-55° C.; medium rare as 55° C.-60° C.; medium as 60° C.-65° C.; medium well as 65° C.-69° C.; and well done as 71° C.-100° C.

A composition with a “sharp” melting point undergoes a physical transition change only at or about the target temperature (for example, 71° C. for hamburger patty) with little to no physical transition happening at temperatures below the target temperature.

“Embedded” in a food product as used herein is meant that the composition is somehow incorporated into the raw food product in any variety of manners including but not limited to mixing and/or injection either by hand or mechanically. In an aspect the composition is embedded in the food product such that direct contact with the cooking surface is avoided. For example, in a pre-formed hamburger patty, the composition may be pushed into the hamburger from the side so that the composition does not come directly into contact with the pan in which the hamburger will be cooked. This type of embedment typically leads to more even and consistent melting of the composition at the desired temperature. Generally, the composition is embedded to a degree that it is still visible but that its temperature (and therefore time of melting) is comparable to that of the surrounding food product.

The composition of the invention essentially does not negatively affect the organoleptic properties of the food product in which it is integrated after cooking.

The edible temperature sensitive composition of the invention is lipid based and shows a clear and irreversible physical transition change when temperature reaches a target temperature (e.g. a minimum of 60° C. for meat). The target temperature is a sharp melting point at which harmful food borne pathogens will be inactivated. The physical transition change is readily seen through physical changes of the composition (such as color or shape) within the cooked food product, i.e. the consumer should easily and conveniently be able to identify the change.

The composition of the invention can be used (integrated, inserted) in a variety of food products that may contain a harmful pathogen, such as raw food products, cooled or frozen food products, or products that are generally heated prior to consumption. In aspects the food product is raw; in other aspects the food product could be partially cooked; or in further aspects the food product could be cooked but may require additional heating prior to consumption.

Food products may include meats (beef, pork, lamb, rabbit and goat), poultry, wild game (pheasant, partridge, boar and bison), fish, vegetables (veggie-patties, veggie hamburgers), combinations of vegetables and meat, egg products (quiches, custards, cheesecakes) and baked goods (batters, doughs, cakes, breads, muffins, biscuits, cupcakes, pancakes and the like whether baked, raw or partially baked). Harmful pathogens that may be contained in such raw food products include E. coli O157:H7, Listeria monocytogenes, Salmonella (e.g. Salmonells enteritidis as a representative non-limiting example), Shigella, and Vibrio. Combinations of pathogens may be present. Furthermore, harmful pathogens can also include parasites such as trichinosis found in undercooked and raw pork. Vegetables may be contaminated through contact with sewage run-off and therefore vegetable food products such as veggie burgers are susceptible to contamination by harmful pathogens. The composition of the invention is useful for any food product (raw/uncooked/frozen/cooled/partially cooked & frozen) that may contain one or more harmful pathogens that are inactivated upon heating (i.e. cooking) at temperatures of about 60° C. to about 80° C.

In another aspect, the composition of the invention can be used in a food product, such as steak, that is generally cooked to a specified level of desired degree of doneness that is preferential to persons for consumption. For example, steak prepared rare can be profiled as 52° C.-55° C.; medium rare as 55° C.-60° C.; medium as 60° C.-65° C.; medium well as 65° C.-69° C.; and well done as 71° C.-100° C. These temperature ranges indicate a “desired degree of doneness”.

The temperature sensitive composition of the invention comprises lipid. The lipid has a melt profile of from about 50° C. to about 100° C., such as from about 52° C. to about 55° C., about 55° C. to about 60° C., about 60° C. to about 65° C., about 65° C. to about 69° C., from about 71° C. to about 100° C., or from about 60° C. to about 80° C. (and any ranges therein between). The lipid can be selected from any variety of lipid that has this temperature melt profile. For example the lipid may be selected from but not limited to fatty acids such as palm fat (melting point at 65° C.), stearic fatty acid (melting point at 69° C.), arachidic acid (melting point at 75.5° C.), hydrogenated soybean oil (melting point 80° C.), canola stearin (melting point 70° C.) and combinations thereof. The lipid may be a glyceride (for example a triacylglyceride or diacylglyceride) having this melt profile including mixtures thereof. The type and mixtures of fatty acids for use in the composition is only limited by the melting point falling within the target temperature range. Thus glycerides can be mixed with fatty acids and further other lipids, so long at the melt profile remains in the range of from about 50° C. to about 100° C., such as from about 60° C. to about 80° C. In one aspect of the invention canola stearin is used in the composition of the invention.

The melt profile of the lipid used in the composition may differ from the target temperature only in that it is within the range of the target temperature, that is, from about 50° C. to about 100° C., such as from about 60° C. to about 80° C. In other words the melt profile of the lipid can be selected to have a range of about 65° C. to about 80° C. (or any ranges or specific temperatures therein between) while the target temperature range is about 60° C. to about 80° C. or any specific range therein or specific temperature within that range. So long as the temperature values generally fall within the target temperature range of, for example, 60° C. to 80° C., the temperature numbers for the lipid and target temperature can differ as is understood by one of skill in the art.

The composition of the invention may further comprise a temperature modifier. A temperature modifier may have two purposes: one to alter the temperature of the lipid and the other to change the heat conductance in the food product. Heat conductance will vary depending on the food product characteristics (i.e. water content, fat content, protein content, etc.) Thus the incorporation of temperature modifier(s) simulate the thermal conductivity and behaviour of the food product in which it is used (e.g., meat, flour dough batter). This may help to result in the composition having a sharp melting point, in order to assure it undergoes a physical transition change only at the target temperature (for example, 71° C. for hamburger patty) while placed within the food product.

The composition may comprise up to about 20% by weight temperature modifier as well as any weight in between or any weight range in between (in aspects up to about 19% by weight, up to 18% by weight, up to 17% by weight, up to 16% by weight, up to 15% by weight, up to 14% by weight, up to 13% by weight, up to 12% by weight, up to 11% by weight, up to 10% by weight, up to 9% by weight, up to 8% by weight, up to 7% by weight, up to 6% by weight, up to 5% by weight, up to 4% by weight, up to 3% by weight, up to 2% by weight, up to 1% by weight; in further aspects the amount may be about 1% to about 10%). Temperature modifiers for use in the present composition include but are not limited to carbohydrates which may be selected from dietary polymers such as polysaccharides. Suitable polysaccharides include but are not limited to carboxymethyl cellulose (CMC), carrageenans, alginate and combinations thereof. The carbohydrates used in the composition may be present in the amount of about 0%-10% by weight of the composition. Other suitable temperature modifiers may be selected from proteins that may be selected from a variety of plant, animal and milk proteins. Suitable proteins for use include but are not limited to canola protein isolate, soy proteins (i.e. soy protein isolates, hydrolyzed soy proteins), whey protein (i.e. beta-lactoglobulin and alpha-lactalbumin), milk proteins (i.e. casein) and mixtures thereof. Still other temperature modifiers may be included and selected from thickening, stabilizing and emulsifying agents. Emulsifiers for use in the composition of the invention may be selected from a variety of plant, or synthetic compounds. Suitable emulsifiers for use include but are not limited to lecithin form soy and synthethic ones (i.e. ammonium phosphatide) and mixtures thereof.

The composition of the invention undergoes a visual and permanent (irreversible) physical change. In one aspect the physical phase change is due to the sharp melting point or a wider melting range (e.g. about 60° C. to about 80° C.) whereby the composition will “melt” out of the food product and thus create visual and clear “holes” in the food product upon reaching the proper temperature (as they melt and disappear) thus indicating that any harmful pathogens are essentially inactivated and the food product is ready and safe for consumption. Thus this is a physical visual and permanent physical change. This target temperature for inactivating pathogens is described as about 60° C. to about 80° C. but may include any specific individual temperature therein including but not limited to: 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C. and 80° C. The target temperature may also include any range of about 61° C. to 74° C., 62° C. to 73° C., 64° C. to 72° C., 65° C. to 71° C., 66° C. to 70° C., 67° C. to 69° C. and further combinations of any range point between 60° C. and 80° C. For example a target temperature for ground beef is 71° C., for whole cuts of beef is 63° C., for poultry is 72° C. for pork is 60° C., for wild game is 71° C. and for dairy is 62° C. Specific target temperatures can be accomplished within 60° C. to 80° C. depending on food safety guidelines and regulations as presented in various jurisdictions such as the USDA and the Canadian Food Inspection Agency.

In a further embodiment, when the composition is used as an indicator of the desired degree of the doneness of steak, for example, the target temperature is described as being from about 52° C. to about 55° C. for rare, about 55° C. to about 60° C. for medium-rare, about 60° C. to about 65° C. for medium, about 65° C. to about 69° C. for medium-well done, or from about 71° C. to about 100° C. for well done.

The composition may also optionally comprise an edible colour indicator in an amount of up to about 5% by weight, in aspects about 0.01% to about 5% by weight (and any amount and range therein) including any specific amount in between or any range therein between. Adding a colour indicator is a second visual and permanent aspect of the composition in certain embodiments. As incorporated into the lipid based composition, once the composition reaches the target temperature and “melts” forming a hole/indent in the cooked food product, the colour will be visible where the composition was incorporated into the food product indicating that the target temperature was reached. Colour indicators may be natural or synthetic. Approved food grade colorants include natural colorants and synthetic dyes and lakes approved for human consumption. Dyes are typically water-soluble colorants, while lakes typically are prepared as a dye absorbed on to a water-insoluble substrate to create a non-migrating pigment for applications where water may be present and no migration of the color is desired. The lake can also be easily incorporated into water-insoluble foodstuffs such as systems containing oils and fats. Natural food dyes may include caramel coloring (brown), annatto (orange), copper chlorophyllin (green), carmine/cochineal extract (red), beet juice (red), paprika oleoresin (red-orange), saffron (yellow), turmeric (yellow-orange), beta carotene (yellow-orange), black carrot and many other fruit and vegetable sources of anthocyanins (pink-red-purple), and other colorants derived from fruit or vegetable juices or extracts. FD&C approved synthetic food dyes may include FD&C Blue No. 1, FD&C Blue No. 2, FD&C Green No. 3, FD&C Red No. 40, FD&C Red No. 3, FD&C Yellow No. 5, and FD&C Yellow No. 6. A colour indicator may include mixtures of more than one food grade synthetic dye or lake and/or natural colorant or pigment. Also within the scope of a colour indicator for use in the present invention are food grade lipophilic phytochemicals and plant based food ingredients. In terms of colors, the food grade lipophilic phytochemicals and plant based food ingredients may include but not be limited to lutein (a yellow/orange pigment found in dark green leafy vegetables), lycopene (red pigment found in tomato), and the saffron spice (used to contribute a luminous yellow-orange colouring to different foods). The colour indicator is optional and might not be suitable for humans with visual colour impairments.

The composition of the invention can be made into discrete units of desirable size and shape (i.e small plugs, balls, etc.). As discrete units the composition can be made into any desirable size and shape and is only limited in size with respect to the ability to clearly visually see the permanent physical phase transformation. Therefore in aspects, the discrete units can be of any size such as about 0.5-12 mm in diameter or more. The composition of the invention can be stored at a variety of temperatures including room temperature, but in aspects, refrigerated temperatures (about 4° C.) or temperatures below the freezing point (0° C.) are desirable and do not negatively affect the integrity of the composition. The composition of the invention can be stored as incorporated into frozen and refrigerated food products.

The composition of the invention will visually and permanently undergo the visual physical transition regardless of the method of cooking the food product in which it is incorporated into. Thus the food product can be baked, grilled, fried, boiled, barbecued, microwaved and toasted using any variety of known food heating appliances.

Patty Type Food Products (Ground Meat, Veggie Patties, Pancakes)

The compositions of the invention have particular use in the patty industry (meat, vegetable and seafood), especially that of burgers (frozen and fresh). This is especially important since harmful pathogens (most notably E. coli O157:H7) that are typically present in the outside of the meat in the form of a steak, are ground and integrated into the middle of the burger patty. Therefore proper cooking to ensure that the harmful pathogens integrated into the middle of the patty is essential in order not to get ill. In this embodiment discrete units of desirable size are integrated into the patty at one or more locations in the structure. During cooking, once the internal temperature reaches a pre-determined temp such as 70° C. the composition will melt and form a hole that is readily seen by the customer. It is then safe to eat the cooked patty. It might be desirous to incorporate more than one discrete unit of the composition in a patty, since the method of cooking may not be even on each side of the product and the patty may have different thickness throughout. Having more than one discrete unit of the composition will ensure the entire patty is properly cooked and has reached the target temperature indicating that the harmful pathogens are killed and the product can be safely consumed.

This is also applicable to veggie burgers containing chopped/ground vegetables, eggs and flour, baked goods, and combination burgers including both ground meat and vegetables.

Egg-Containing Food Products

The compositions of the invention have further use in baked goods incorporating raw eggs and raw egg components such as the yolk and/or white and the like. For example, the compositions may be incorporated into a variety of raw or partially cooked/baked doughs, batters, cookie doughs, cakes, custards, creams and the like.

Steaks/Fillets Whole Muscle Food Products

The composition of the invention can be pre-inserted into different sizes of steaks, fish fillets and/or chicken fillets, pork/lamb chops as desired. This can be done by punching into the meat or slitting the steak/fillet at various locations therein and inserting a discrete unit of the composition of the invention.

Again, this can be done prior to freezing of the steak/fillet or by the consumer at home into a fresh steak/fillet.

The composition of the invention is thus used to indicate the “desired degree of doneness” of a food product in order to clearly indicate that the food product is properly cooked such that any contained harmful pathogen is inactivated and the cooked food product can be safely consumed. It is within the realm of the invention that the composition be used to indicate cooking preferences for meat, more specifically, beef, lamb, etc. Thus the composition of the invention can be modified with respect to the target temperature to indicate conditions of the meat as rare, medium rare and well done. For example rare can be profiled as 52° C.-55° C.; medium rare as 55° C.-60° C.; medium as 60° C.-65° C.; medium well as 65° C.-69° C.; and well done as 71° C.-100° C.

Methods of Making the Composition

The edible temperature sensitive composition described herein is made by blending a lipid with a desired melt profile together with a weight temperature modifier and, optionally, a weight colour indicator to form a homogeneously dispersed solution. Generally these are blended while the lipid is heated and in liquid form. Alternatively, they can be blended at room temperature and then heated and melted to for a homogenously dispersed solution. The homogeneously dispersed solution is then cooled and re-solidified into discrete units, which can then be embedded in a desired food product.

The function and advantage of the embodiments of the present invention will be more fully understood from the examples below. The following actual examples are intended to illustrate the benefits of the present invention, but do not exemplify the full scope of the invention.

### EXAMPLES

### Example One

### Thermal Behaviour of Biopolymer Mixtures During Cooking

A mixture of biopolymers (e.g. protein, lipid, and carbohydrate) was investigated to undergo an irreversible physical change at 71° C. The thermal behavior [e.g. solid fat contents (SFC)] and fatty acids compositions (FAC) of the selected materials was determined by nuclear magnetic resonance (NMR) and gas chromatography (GC), respectively.

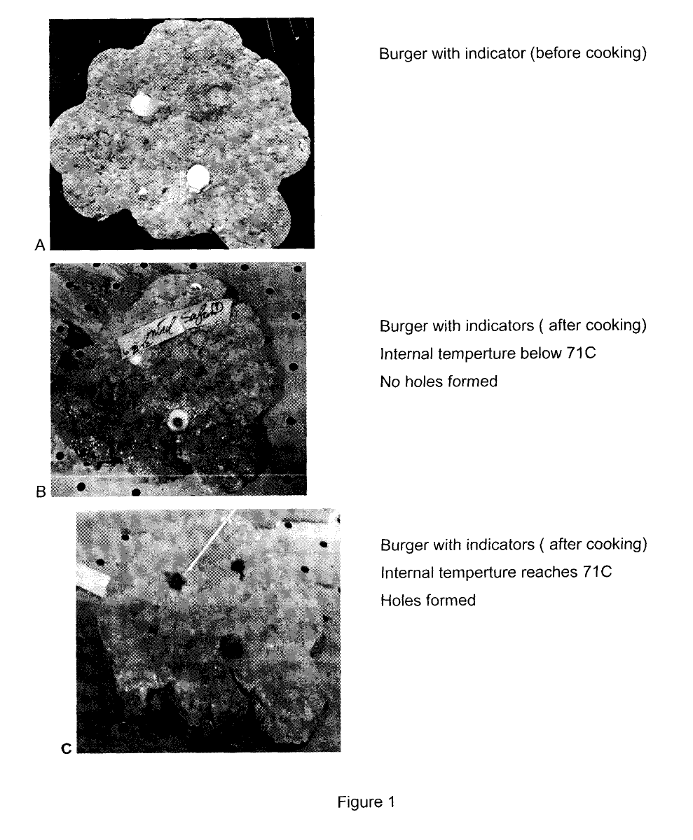

The apparent physical and visual changes (e.g., color and/or other physical changes which could be used for visual detection) were investigated within the cooking processes. For example, a mixture of canola stearin and lutein we have selected and inserted into the burgers formed holes when the internal temperature of the burgers reached 71° C. The behaviours of such mixtures within the tested hamburgers, during the cooking process, are summarised in FIG. 1.

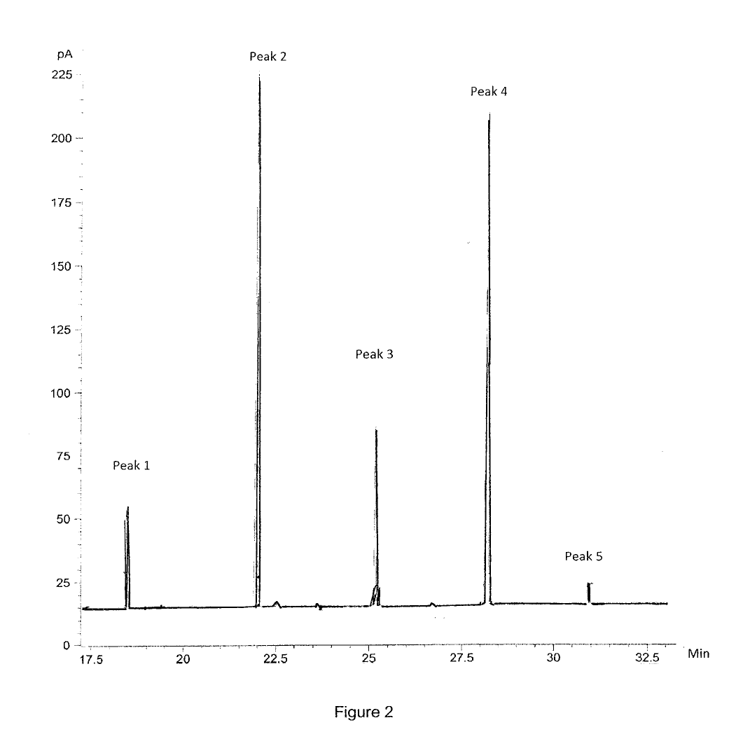

FIG. 2 showed the fatty acids composition of these mixtures; i.e., determined by GC. Table 1 identifies the names of the fatty acids at each peak of FIG. 2.

TABLE 1
Fatty acids corresponding to different peaks of FIG. 2.

| | | Lipid | |
|---|---|---|---|
| Peak ID | Common Name | Numbers | chemical formula |
| Peak 1 | Palmitic acid | C16:0 | CH₃(CH₂)₁₄CO₂H |
| Peak 2 | Stearic acid | C18: | CH₃(CH₂)₁₆CO₂ |
| Peak 3 | Oleic acid | C18:1 | CH₃(CH₂)₇CH═CH(CH₂)₇COOH. |
| Peak 4 | Behenic acid | C22:0 | CH₃(CH₂)₂₀COOH |
| Peak 5 | Lignoceric acid | C24:0 | CH₃(CH2)₂₂COOH |

The melting point or melting range was determined of small edible solid candidates. The solid fat content (SFC) was used to characterize the materials in the initial studies. Table 2 shows an example of the solid fat content of different small crystalline edible solid candidates as determined by NMR. The data indicate that 100% Canola stearin has a sharp melting point at 70° C. (Table 2, Sample A). Incorporating Kappa-carrageenan at 1, 5 and 10%, did not alter thermal behaviour (sharp melting range) of the canola stearin, which had a sharp melting point at 70° C. (Table 2, Sample B, C, D).

In summary, the mixture of canola stearin and lutein and/or lycopene was found to be suitable as an edible indicator for a product such as hamburger, as shown in FIG. 1 as it formed a hole within a meat hamburger when it reached the target temperature of 71° C.

### 1. Materials and Chemicals

All ingredients used to form the sensors are of food grade. For the solvents used for analysis of the sensors high-performance liquid chromatography grade chemicals were used. The fatty acid standards used for the gas chromatography (GC) analyses were purchased from SGE, USA.

The canola stearin (a fully hydrogenated rapeseed) was obtained from Palsgaard (Morris Plains, USA). Palsgaard Incorporated 101 Gibraltar Drive Dr., Suite 2B Morris Plains, N.J. 07950 USA.

### 2. Melting Point Determination

Melting point was determined in accordance with the AOCS official method Cc 1-25(AOCS, 2009). Briefly, a capillary tube was dipped in the completely liquid sample until the sample rose to about 10 mm high in the tube. The capillary tubes then were chilled at 4° C. for 16 h before being immersed in a beaker of boiled distilled water. The water bath was stirred and heated, and the temperature was recorded when the fat inside the tube was completely clear. Three replicates of this analysis were performed.

### 3. Hamburger Cooking Protocols

For simplicity, a steaming process was used to simulate the hamburger cooking process. Briefly, the double boiler was filled with water, and heated until water reached and maintained at 100° C. in order to obtain continuous steam generation. The hamburgers were then placed on the top perforated layer of the boiler. Temperatures at the top, center and bottom of the hamburgers were monitored by a thin thermocouple at 1 min interval. Hamburgers were considered to be fully cooked when their internal temperature reached 70° C. (determined by the thermocouple unit). The physical changes of the indicators placed within hamburgers were under constant visual observation and photographed periodically.

### 4. FAC Analysis by Gas Chromatograph (GC)

A gas chromatograph (Agilent 6890, CA) equipped with a BP×70 column (60 m×0.22 mm i.d.) and flame ionization detector was used for the FAC analysis. Initially, the column was held at 110° C. for 1 min and programmed to rise to 230° C. at a rate of 4.0 C./min. The column was then held at 230° C. for 10 min. The carrier gas was helium, and the total gas flow rate was 25cm/sec. The detector temperature was 280° C.

### 5. SFC Analysis By Nuclear Magnetic Resonance (NMR)

SFC values of each sample were determined by using a Bruker Minispec Solid Fat Analyzer (Bruker, Canada). NMR tubes (10 mm in diameter) were filled with 1 mL of dietary small crystaline edible solid mixture and capped. Tempering pre-treatment of all samples was carried out using IUPAC Method 2. 150. SFC values were determined at 10° C., 20° C., 30° C., 40° C., 50° C., 60° C., 70° C. and 80° C..

TABLE 2
Example of solid fat content of mixtures
of Canola stearin and Kappa-carrageenan

| | |
|---|---|
| Tempera- | Sample |

| tures | A | B | C | D | E | F |
|---|---|---|---|---|---|---|
| 10 | 98.99 | 98.98 | 98.92 | 98.92 | 90.61 | 80.32 |
| 20 | 98.77 | 98.81 | 98.73 | 98.69 | 89.89 | 78.75 |
| 30 | 98.55 | 98.62 | 98.50 | 98.53 | 89.44 | 77.89 |
| 40 | 98.19 | 98.18 | 98.18 | 98.16 | 88.90 | 76.81 |
| 50 | 97.28 | 97.42 | 97.37 | 97.31 | 87.95 | 76.41 |
| 60 | 76.17 | 76.83 | 80.38 | 82.11 | 81.88 | 75.85 |
| 70 | 0.10 | 0.04 | 0.25 | 0.11 | 36.90 | 75.16 |
| 80 | 0.11 | 0.02 | 0.08 | 0.11 | 36.70 | 74.74 |

Note:
A: 100% Canola stearin;
b: 99% Canola stearin + 1% Kappa-carrageenan;
C: 95% Canola stearin + 5% Kappa-carrageenan;
D: 90% Canola stearin + 10% Kappa-carrageenan;
E: 50% Canola stearin + 50% Kappa-carrageenan;
F: 100% Kappa-carrageenan.

### Example Two

### Placement of the Composition within a Hamburger Patty for Pan-Frying

The indicator composition described herein was examined to determine suitable placement within a hamburger patty to give a reproducible and accurate end-point temperature determination.

There were four formats of indicator placement examined in the hamburgers. It was found that pushing the indicators from the middle side of hamburger provided good results. It was believed that this format permitted the best heat conduction between the indicators and hamburgers. The indicators were found to melt much faster if they came into contact directly with the pan surface rather than the hamburger. Pushing indicators in the hamburgers allows for the indicators to heat equally and slowly and more representatively of the hamburger itself. In this way the indicators can indicate whether the hamburgers are cooked to their proper end-point temperature.

Two forms of hamburgers were investigated, both supplied by Cardinal Meats. One format was the Standard Fill hamburger (SF), the other was the Natural Tender Form hamburger (NTF). Their production and properties were very different, so both hamburgers were investigated with the developed temperature indicators.

The SF hamburger was made by extruding a patty of meat batter in a pre-formed shape whereas the NTF hamburger was made by extruding ground meat filaments and the shape was made using a clam shaped device. The NTF hamburger was a much more porous hamburger which retained more flavour and juices than the SF hamburger.

After the hamburgers were defrosted, indicators were pushed through the hamburgers and the hamburgers were cooked immediately. The cooking time started when the hamburgers were put on the heated pan surface and ended when the indicators were totally melted and had disappeared. The hamburgers were flipped every two minutes to avoid burning. During the process, the temperature of the hamburgers was recorded every 60 seconds.

### NTF Hamburger:

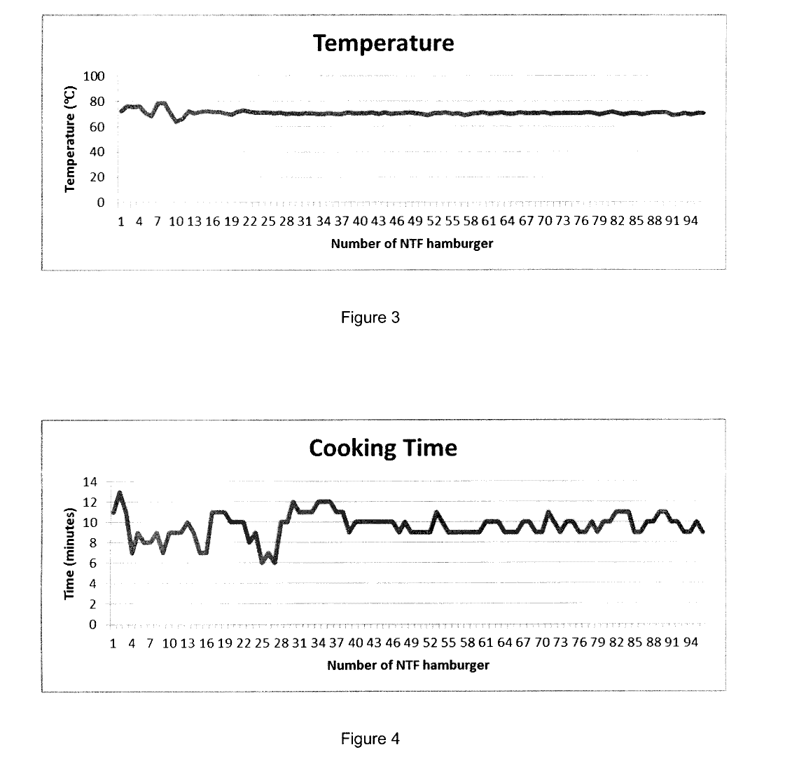

The resultant graphs of the center temperatures of NTF hamburgers when the indicators were totally melted and had disappeared are shown in FIG. 3. It was determined from cooking over 96 NTF hamburgers over a period of several days that the temperatures of the centers of the NTF hamburgers (when the indicators totally melted and disappeared) was around 70 ° C. +/−1° C. This was well within the temperature required to inactivate any pathogenic bacteria that may be present within the NTF hamburger at it coldest spot (i.e., its center).

Data on cooking time for NTF hamburgers to reach their required end-point temperature and the indicator to melt is shown in FIG. 4. The cooking time was found to fluctuate to some extent, but was found to be around 10 minutes for NTF hamburgers.

The data collected for the NTF hamburgers is shown in Tables 3, 4, 5, 6, 7, 8, 9, and 10, below.

The data collected for the SF hamburgers is shown in Tables 11 and 12 below.

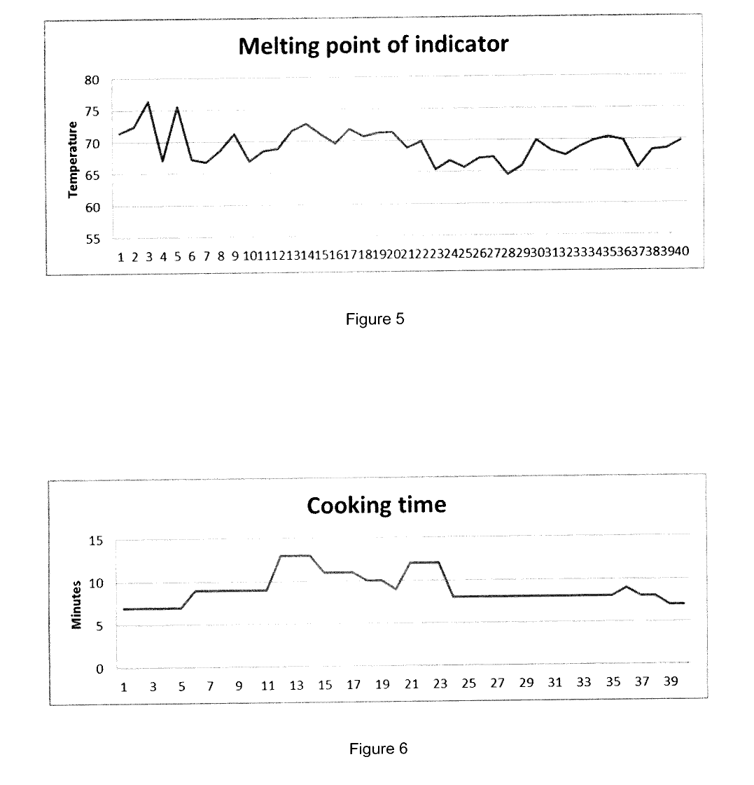

The resultant graphs of the center temperatures of Standard Fill hamburgers when the indicators were totally melted and disappear are shown in FIGS. 5 & 6. It was determined from cooking over 40 Standard Fill Hamburgers over a period of several days that the temperatures of the centers of the Standard Fill Hamburgers (when the indicators totally melted and disappeared) was around 70 ° C.+/−5° C. (FIG. 5). This was well within the temperature required to inactivate any pathogenic bacteria that may be present within the Standard Fill Hamburgers at it coldest spot (i.e., its center). Data on cooking time for Standard Fill Hamburgers to reach their required end-point temperature and the indicator to melt was shown in FIG. 6. The cooking time was found to fluctuate to some extent, but found to be around 10 minutes for Standard Fill Hamburgers.

TABLE 3
Trial #1 for Indicator Composition in NTF Hamburgers

| Hamburger | | 1 | 2 | 3 | 4 | 5 | 6 | 7 | 8 | 9 | 10 | 11 | 12 |
|---|---|---|---|---|---|---|---|---|---|---|---|---|---|
| Size (Before cooking) cm | | 11.0 | 11.1 | 11.0 | 11.3 | 11.2 | 11.4 | 11.1 | 11.5 | 10.5 | 10.5 | 10.4 | 11.1 |
| (horizontal) | | | | | | | | | | | | | |
| Size (Before cooking) cm | | 11.3 | 11.0 | 11.1 | 11.1 | 11.5 | 11.3 | 11.4 | 11.4 | 11.4 | 11.3 | 11.4 | 11.3 |
| (vertical) | | | | | | | | | | | | | |
| Thickness (Before | | 1.5 | 1.6 | 1.5 | 1.6 | 1.7 | 1.5 | 1.6 | 1.5 | 1.4 | 1.4 | 1.4 | 1.5 |
| cooking) | | | | | | | | | | | | | |
| Temperature (Before | | 0 | 0.3 | −0.5 | 6.4 | 7.9 | 4.0 | 16.7 | 9.8 | 6.6 | 12.7 | 12.8 | 12.8 |
| cooking) | | | | | | | | | | | | | |
| 1 | min | 6.3 | 5.5 | 1.9 | 22.0 | 18.5 | 17.6 | 19.5 | 19.1 | 16 | 16.1 | 16.3 | 16.2 |
| 2 | min | 12.2 | 8.5 | 4.4 | 30.9 | 32.6 | 28.0 | 34.2 | 47.8 | 36.8 | 21.4 | 20.6 | 19.4 |
| 3 | min | 18.2 | 16.3 | 11.2 | 35.3 | 38.8 | 42.6 | 37.2 | 33.3 | 32.5 | 28.8 | 32.1 | 33.4 |
| 4 | min | 25.4 | 26.6 | 13.4 | 55.2 | 65.6 | 59.6 | 43.9 | 43.3 | 45.2 | 37.0 | 40.0 | 40.3 |
| 5 | min | 28.3 | 35.3 | 34.8 | 50.3 | 52.6 | 50.0 | 63.3 | 59.6 | 55.8 | 43.8 | 45.6 | 46.9 |
| 6 | min | 39.7 | 42.5 | 42.9 | 61.4 | 60.6 | 58.8 | 67.5 | 65.9 | 61.8 | 52.7 | 53.8 | 54.4 |
| 7 | min | 62.2 | 58.3 | 51.0 | 76.2 | 72.5 | 68.8 | 74.3 | 70.7 | 71.4 | 53.1 | 55.4 | 57.1 |
| 8 | min (flip) | 65.5 | 50.9 | 46.5 | | 66.4 | 68.1 | 78.3 | 72.1 | | 59.7 | 61.6 | 61.9 |
| 9 | min | 65.3 | 65 | 63.3 | | 70.3 | | | 78.9 | | 63.8 | 66.1 | 72.3 |
| 10 | min | 62.4 | 68.3 | 63.2 | | | | | | | | | |
| 11 | min | 72.1 | 72.4 | 75.4 | | | | | | | | | |
| 12 | min | | 66.3 | | | | | | | | | | |
| 13 | min | | 76.3 | | | | | | | | | | |

| | | | | | | | | | | | | |
|---|---|---|---|---|---|---|---|---|---|---|---|---|
| Size (after cooking) | 9.3 | 9.5 | 9.2 | 8.9 | 8.7 | 8.4 | 9.4 | 8.7 | 9.0 | 9.1 | 8.8 | 9.1 |
| (horizontal) | | | | | | | | | | | | |
| Size (after cooking) cm | 9.2 | 9.1 | 9.3 | 8.5 | 9.2 | 8.7 | 9.0 | 9.0 | 9.8 | 8.9 | 9.5 | 9.4 |
| (horizontal) | | | | | | | | | | | | |
| Thickness (After cooking) | 1.5 | 1.6 | 1.7 | 1.3 | 1.6 | 1.5 | 1.3 | 1.3 | 1.6 | 1.3 | 1.4 | 1.4 |

TABLE 4
Trial #2 for Indicator Composition in NTF Hamburgers

| Hamburger | | 1 | 2 | 3 | 4 | 5 | 6 | 7 | 8 | 9 | 10 | 11 | 12 |
|---|---|---|---|---|---|---|---|---|---|---|---|---|---|
| Size (Before cooking) cm | | 10.5 | 11.1 | 10.2 | 11.1 | 10.8 | 10.6 | 10.5 | 10.5 | 10.7 | 10.8 | 10.5 | 10.6 |
| (horizontal) | | | | | | | | | | | | | |
| Size (Before cooking) cm | | 11.5 | 10.9 | 10.6 | 11.5 | 11.1 | 11.6 | 11.0 | 10.8 | 11.0 | 10.5 | 10.5 | 10.5 |
| (vertical) | | | | | | | | | | | | | |
| Thickness (Before | | 1.5 | 1.5 | 1.5 | 1.5 | 1.7 | 1.5 | 1.4 | 1.5 | 1.3 | 1.5 | 1.5 | 1.7 |
| cooking) | | | | | | | | | | | | | |
| Temperature (Before | | 20.6 | 17.6 | 15.7 | 20.4 | 20.3 | 20.5 | 20.9 | 18.8 | 19.0 | 19.2 | 20.9 | 20.9 |
| cooking) | | | | | | | | | | | | | |
| 1 | min | 32.4 | 31.3 | 24.1 | 25.5 | 23.7 | 22.8 | 23.7 | 23.8 | 23.5 | 22.3 | 23.4 | 23.3 |
| 2 | min (flip) | 34.5 | 35.1 | 30.3 | 30.0 | 23.6 | 24.3 | 25.6 | 26.3 | 25.3 | 25.0 | 26 | 26.7 |
| 3 | min | 35.4 | 37.9 | 43.4 | 44.4 | 30.5 | 36.6 | 37 | 42 | 46.6 | 49.8 | 31.9 | 35.7 |
| 4 | min (flip) | 46.3 | 47.2 | 49.2 | 50.0 | 37.2 | 38.4 | 39.3 | 49.8 | 48.6 | 49.1 | 47.2 | 47.6 |
| 5 | min | 50.3 | 53.4 | 66.7 | 67.1 | 38.2 | 45.9 | 48.2 | 57.5 | 54.0 | 55.3 | 48.0 | 49.9 |
| 6 | min (flip) | 51.8 | 57.1 | 69.6 | 70.3 | 55.1 | 53.0 | 51.9 | 62.9 | 63.2 | 63.7 | 59.6 | 58.7 |
| 7 | min | 72.7 | 69.8 | 72.1 | 71.5 | 55 | 56 | 57.7 | 70.4 | 69.9 | 69.4 | 63.1 | 63.3 |
| 8 | min (flip) | 65.2 | 66.2 | | | 59.6 | 58.4 | 56.1 | 67.4 | 66 | 63.3 | 71.1 | 65.9 |
| 9 | min | 69.6 | 71.4 | | | 63.1 | 66 | 67.9 | 65.2 | 67.1 | 64.8 | | 70.8 |
| 10 | min (flip) | 70.4 | | | | 65.5 | 64.8 | 68.4 | 71.8 | 72.8 | 71.7 | | |
| 11 | min | | | | | 71.7 | 70.7 | 69.2 | | | | | |

| | | | | | | | | | | | | |
|---|---|---|---|---|---|---|---|---|---|---|---|---|
| Size (after cooking) | 8.4 | 8.6 | 8.5 | 9.5 | 9.2 | 8.4 | 8.8 | 8.4 | 8.2 | 9 | 8.8 | 8.9 |
| (horizontal) | | | | | | | | | | | | |
| Size (after cooking) cm | 9.4 | 9.2 | 9.2 | 10.0 | 9.0 | 9.4 | 9.2 | 9.1 | 9.0 | 8.4 | 8.6 | 8.4 |
| (horizontal) | | | | | | | | | | | | |
| Thickness (After cooking) | 1.5 | 1.6 | 1.5 | 1.5 | 1.7 | 1.5 | 1.6 | 1.6 | 1.4 | 1.7 | 1.4 | 1.4 |

TABLE 5
Trial #3 for Indicator Composition in NTF Hamburgers

| Hamburger | | 1 | 2 | 3 | 4 | 5 | 6 | 7 | 8 | 9 | 10 | 11 | 12 |
|---|---|---|---|---|---|---|---|---|---|---|---|---|---|
| Size (Before cooking) cm | | 11.0 | 11.5 | 10.8 | 11.1 | 11.2 | 10.9 | 11.2 | 11.2 | 11.0 | 11.0 | 10.9 | 11.1 |
| (horizontal) | | | | | | | | | | | | | |
| Size (Before cooking) cm | | 10.7 | 10.7 | 11.0 | 11.0 | 10.5 | 10.6 | 10.9 | 10.8 | 10.6 | 11.1 | 10.9 | 11.1 |
| (vertical) | | | | | | | | | | | | | |
| Thickness (Before | | 1.5 | 1.5 | 1.7 | 1.5 | 1.6 | 1.6 | 1.5 | 1.5 | 1.5 | 1.5 | 1.5 | 1.5 |
| cooking) | | | | | | | | | | | | | |
| Temperature (Before | | 5.3 | 7.1 | 15.5 | 19.1 | 17.3 | 16.9 | 23.1 | 22.4 | 22.4 | 24.4 | 23.5 | 22.8 |
| cooking) | | | | | | | | | | | | | |
| 1 | min | 20.3 | 20.4 | 21.2 | 28.6 | 27.8 | 28.9 | 23.5 | 23.3 | 23.0 | 25.1 | 24.9 | 23.5 |
| 2 | min (flip) | 25.8 | 24.4 | 30.9 | 24.3 | 23.9 | 21.2 | 28.3 | 27.9 | 26.6 | 26.2 | 25.7 | 25.1 |
| 3 | min | 53.0 | 50.9 | 51.3 | 37.1 | 37.9 | 40.9 | 33.0 | 33.6 | 34.6 | 33.1 | 33.9 | 33.5 |
| 4 | min (flip) | 53.9 | 54.2 | 55.6 | | | | 35.3 | 35.7 | 36.0 | 40.1 | 37.7 | 35.7 |
| 5 | min | 60.8 | 57.2 | 64.6 | | | | 46.8 | 46.2 | 46.5 | 43.0 | 47.6 | 48.6 |
| 6 | min (flip) | 71.1 | 60.4 | 70.9 | | | | 44.1 | 45.0 | 44.6 | 43.1 | 45.9 | 48.1 |
| 7 | min | | 70.3 | | 53.3 | 61.5 | 64.5 | 48.1 | 53.7 | 57.7 | 57.1 | 56.1 | 54.4 |
| 8 | min (flip) | | | | 60.1 | 62.8 | 62.2 | 51.3 | 53.3 | 55.0 | 53.5 | 54.4 | 55.1 |
| 9 | min | | | | 64.4 | 67.1 | 69.3 | 67.9 | 68.3 | 69.5 | 65.5 | 63.9 | 62.9 |
| 10 | min (flip) | | | | 70.1 | 70.6 | 63.8 | 66.6 | 66.4 | 67.1 | 66.9 | 67.0 | 67.9 |
| 11 | min | | | | | | 67.8 | 70.3 | 70.5 | 69.7 | 62.9 | 62.8 | 62.0 |
| 12 | min | | | | | | 70.2 | | | | 70.2 | 70.3 | 69.9 |

| | | | | | | | | | | | | |
|---|---|---|---|---|---|---|---|---|---|---|---|---|
| Size (after cooking) | 9.4 | 9.5 | 9.2 | 9.6 | 9.3 | 9.3 | 9.1 | 9.5 | 9.5 | 9.2 | 9.0 | 9.2 |
| (horizontal) | | | | | | | | | | | | |
| Size (after cooking) cm | 8.3 | 8.5 | 8.5 | 8.5 | 8.2 | 8.4 | 8.5 | 8.5 | 8.7 | 8.7 | 8.5 | 8.5 |
| (horizontal) | | | | | | | | | | | | |
| Thickness (After cooking) | 1.7 | 1.7 | 1.8 | 1.6 | 1.7 | 1.7 | 1.6 | 1.6 | 1.7 | 1.5 | 1.6 | 1.5 |

TABLE 6
Trial #4 for Indicator Composition in NTF Hamburgers

| Hamburger | | 13 | 14 | 15 | 16 | 17 | 18 | 19 | 20 | 21 | 22 | 23 | 24 |
|---|---|---|---|---|---|---|---|---|---|---|---|---|---|
| Size (Before cooking) cm | | 11.0 | 11.2 | 11.2 | 11.0 | 10.9 | 11.2 | 11.0 | 10.9 | 10.9 | 11.0 | 11.0 | 11.2 |
| (horizontal) | | | | | | | | | | | | | |
| Size (Before cooking) cm | | 10.8 | 10.9 | 11.1 | 10.7 | 11.0 | 10.8 | 11.2 | 10.9 | 10.8 | 10.3 | 10.4 | 10.4 |
| (vertical) | | | | | | | | | | | | | |
| Thickness (Before | | 1.5 | 1.5 | 1.6 | 1.4 | 1.4 | 1.5 | 1.5 | 1.5 | 1.5 | 1.5 | 1.5 | 1.4 |
| cooking) | | | | | | | | | | | | | |
| Temperature (Before | | 6.1 | 2.3 | 1.4 | 18.9 | 16.7 | 17.7 | 20.2 | 20.4 | 20.6 | 26.5 | 25.9 | 23.2 |
| cooking) | | | | | | | | | | | | | |
| 1 | min | 23.0 | 19.5 | 17.1 | 22.6 | 21.2 | 21.5 | 24.1 | 23.9 | 24.1 | 22.3 | 23.3 | 26.1 |
| 2 | min | 31.8 | 31.0 | 23.3 | 25.5 | 25.1 | 23.1 | 23.9 | 27.2 | 29.7 | 26.1 | 25.6 | 26.3 |
| 3 | min | 28.9 | 30.4 | 34.2 | 30.3 | 32.6 | 34.4 | 29.0 | 30.3 | 34.3 | 35.3 | 38.5 | 41.4 |
| 4 | min (flip) | 31.0 | 32.3 | 35.7 | 36.7 | 37.1 | 37.2 | 33.0 | 34.8 | 37.0 | 46.6 | 45.8 | 51.3 |
| 5 | min | 44.5 | 45.3 | 52.1 | 40.4 | 43.3 | 48.4 | 47.5 | 48.9 | 51.5 | 44.0 | 45.8 | 51.3 |
| 6 | min (flip) | 51.6 | 52.7 | 54.6 | 47.4 | 49.5 | 50.1 | 43.8 | 46.1 | 48.4 | 53.4 | 53.5 | 57.2 |
| 7 | min | 54.5 | 54.7 | 60.8 | 61.0 | 61.1 | 61.8 | 62.0 | 62.3 | 63.2 | 61.3 | 62.0 | 62.6 |
| 8 | min (flip) | 66.2 | 65.3 | 66.3 | 57.0 | 61.4 | 61.8 | 63.5 | 64.9 | 66.0 | 62.9 | 67.4 | 64.8 |
| 9 | min | 68.1 | 67.2 | 70.3 | 70.4 | 71.1 | 72.2 | 69.1 | 67.0 | 65.3 | 68.1 | 70.7 | 68.5 |
| 10 | min (flip) | 68.3 | 68.2 | | 70.3 | 70.3 | 70.9 | 69.8 | 70.9 | 70.1 | 70.4 | | 68.5 |
| 11 | min | 69.9 | 71.3 | | | | | | | | | | |

| | | | | | | | | | | | | |
|---|---|---|---|---|---|---|---|---|---|---|---|---|
| Size (after cooking) | 8.9 | 9.0 | 9.5 | 9.5 | 9.2 | 9.0 | 9.0 | 8.9 | 9.1 | 9.3 | 8.9 | 8.9 |
| (horizontal) | | | | | | | | | | | | |
| Size (after cooking) cm | 8.9 | 8.6 | 8.8 | 8.6 | 8.4 | 8.6 | 8.4 | 8.4 | 8.3 | 8.3 | 8.6 | 8.4 |
| (horizontal) | | | | | | | | | | | | |
| Thickness (After cooking) | 1.6 | 1.6 | 1.6 | 1.7 | 1.6 | 1.7 | 1.5 | 1.6 | 1.6 | 1.6 | 1.5 | 1.6 |

TABLE 7
Trial #5 for Indicator Composition in NTF Hamburgers

| Hamburger | | 1 | 2 | 3 | 4 | 5 | 6 | 7 | 8 | 9 | 10 | 11 | 12 |
|---|---|---|---|---|---|---|---|---|---|---|---|---|---|
| Size (Before cooking) cm | | 10.6 | 10.9 | 11.2 | 11.4 | 11.3 | 10.9 | 10.9 | 10.9 | 11.1 | 11.5 | 10.6 | 11.2 |
| (horizontal) | | | | | | | | | | | | | |
| Size (Before cooking) cm | | 11.3 | 10.8 | 10.9 | 10.7 | 10.6 | 10.6 | 10.9 | 10.8 | 10.9 | 10.7 | 10.6 | 11.2 |
| (vertical) | | | | | | | | | | | | | |
| Thickness (Before | | 1.5 | 1.5 | 1.5 | 1.4 | 1.5 | 1.4 | 1.4 | 1.5 | 1.5 | 1.4 | 1.4 | 1.4 |
| cooking) | | | | | | | | | | | | | |
| Temperature (Before | | 23.5 | 21.9 | 22.4 | 23.4 | 22.9 | 22.7 | 25.3 | 24.4 | 24.4 | 24.4 | 23.9 | 23.8 |
| cooking) | | | | | | | | | | | | | |
| 1 | min | 23.2 | 23.8 | 24.0 | 28.7 | 27.8 | 28.6 | 31.6 | 29.4 | 27.3 | 27.8 | 26.7 | 25.4 |
| 2 | min (flip) | 35.8 | 32.5 | 32.4 | 32.3 | 30.7 | 28.8 | 32.3 | 32.5 | 31.5 | 32.7 | 29.6 | 27.5 |
| 3 | min | 36.6 | 38.3 | 40.6 | 40.3 | 40.6 | 40.4 | 42.7 | 42.8 | 42.6 | 35.7 | 38 | 39.2 |
| 4 | min (flip) | 44.7 | 45.1 | 50.1 | 45.2 | 44.0 | 43.3 | 43.9 | 44.2 | 44.8 | 44.6 | 40.9 | 42.1 |
| 5 | min | 53.0 | 54.9 | 57.2 | 51.6 | 52.5 | 54.2 | 54.0 | 55.0 | 55.6 | 48.2 | 48.6 | 50.3 |
| 6 | min (flip) | 53.9 | 56.7 | 60.2 | 60.1 | 59.1 | 56.5 | 57 | 56.5 | 56.6 | 55.3 | 53.2 | 53.1 |
| 7 | min | 65.5 | 64.9 | 64.7 | 65.4 | 63.1 | 59.9 | 67.5 | 68.9 | 68.5 | 65.6 | 64.3 | 66.0 |
| 8 | min (flip) | 68.0 | 67.0 | 66.1 | 65.4 | 66.7 | 63.1 | 68.6 | 68.9 | 69.7 | 70.9 | 66.4 | 67.0 |
| 9 | min | 70.3 | 70.1 | 69.1 | 70.7 | 68.7 | 66.2 | 70.2 | 70.4 | 69.1 | 70.0 | 70.7 | 71.1 |
| 10 | min (flip) | | | | | 66.7 | 71.0 | | | | | | |
| 11 | min | | | | | 70.4 | | | | | | | |

| | | | | | | | | | | | | |
|---|---|---|---|---|---|---|---|---|---|---|---|---|
| Size (after cooking) | 8.4 | 8.4 | 8.9 | 9.2 | 9.4 | 9.4 | 8.1 | 9.5 | 9.2 | 9.4 | 9.6 | 9.1 |
| (horizontal) | | | | | | | | | | | | |
| Size (after cooking) cm | 8.9 | 8.4 | 8.4 | 8.4 | 8.9 | 8.4 | 8.5 | 8.5 | 8.7 | 8.4 | 8.9 | 8.6 |
| (horizontal) | | | | | | | | | | | | |
| Thickness (After cooking) | 1.5 | 1.5 | 1.4 | 1.6 | 1.6 | 1.5 | 1.5 | 1.5 | 1.5 | 1.5 | 1.5 | 1.5 |

TABLE 8
Trial #6 for Indicator Composition in NTF Hamburgers

| Hamburger | | 13 | 14 | 15 | 16 | 17 | 18 | 19 | 20 | 21 | 22 | 23 | 24 |
|---|---|---|---|---|---|---|---|---|---|---|---|---|---|
| Size (Before cooking) cm | | 10.9 | 11.2 | 11.2 | 11.1 | 11.1 | 11.2 | 10.9 | 11.0 | 10.6 | 11.1 | 11.1 | 11.2 |
| (horizontal) | | | | | | | | | | | | | |
| Size (Before cooking) cm | | 11.1 | 10.5 | 11.0 | 10.8 | 10.6 | 10.9 | 10.5 | 10.9 | 10.9 | 10.5 | 10.9 | 10.8 |
| (vertical) | | | | | | | | | | | | | |
| Thickness (Before | | 1.4 | 1.5 | 1.5 | 1.4 | 1.5 | 1.5 | 1.4 | 1.5 | 1.5 | 1.4 | 1.4 | 1.4 |
| cooking) | | | | | | | | | | | | | |
| Temperature (Before | | 21.9 | 21.2 | 19.5 | 20.9 | 18.9 | 18.8 | 21.7 | 20.0 | 20.0 | 22.1 | 20.9 | 20.7 |
| cooking) | | | | | | | | | | | | | |
| 1 | min | 24.8 | 23.6 | 22.8 | 22.0 | 21.1 | 21.5 | 27.0 | 25.9 | 24.0 | 24.5 | 23.8 | 22.7 |
| 2 | min | 26.6 | 26.4 | 25.5 | 32.8 | 31.8 | 28.2 | 32.0 | 31.0 | 29.1 | 27.9 | 26.9 | 28.0 |
| 3 | min | 35.4 | 36.5 | 37.4 | 35.7 | 37.3 | 38.3 | 41.7 | 41.2 | 41.4 | 39.6 | 39.7 | 40.2 |
| 4 | min (flip) | 40.2 | 39.1 | 38.7 | 44.1 | 45.6 | 46.9 | 43.1 | 44.0 | 45.0 | 46.2 | 47.4 | 46.1 |
| 5 | min | 47.0 | 47.3 | 48.0 | 52.4 | 51.9 | 51.8 | 47.7 | 48.2 | 50.9 | 55.7 | 55.8 | 55.6 |
| 6 | min (flip) | 53.3 | 56.1 | 54.1 | 60.7 | 60.1 | 58.8 | 58.1 | 53.4 | 53.7 | 62.7 | 60.0 | 56.3 |
| 7 | min | 62.8 | 63.1 | 63.2 | 68.0 | 68.2 | 67.9 | 60.9 | 61.4 | 64.8 | 64.2 | 62.5 | 63.6 |
| 8 | min (flip) | 62.5 | 63.2 | 63.6 | 67.6 | 67.2 | 65.8 | 65.3 | 64.5 | 65.7 | 70.0 | 70.4 | 68.9 |
| 9 | min | 68.0 | 67.9 | 67.6 | 70.1 | 69.9 | 71.2 | 65.6 | 68.0 | 70.6 | 70.8 | 66.3 | 69.7 |
| 10 | min (flip) | 69.7 | 70.7 | 70.8 | | | | 70.7 | 70.4 | | | 68.9 | 70.6 |
| 11 | min | | | | | | | | | | | 69.8 | |

| | | | | | | | | | | | | |
|---|---|---|---|---|---|---|---|---|---|---|---|---|
| Size (after cooking) | 9.6 | 9.6 | 9.9 | 9.3 | 9.0 | 9.6 | 9.3 | 9.4 | 9.2 | 9.0 | 9.3 | 9.2 |
| (horizontal) | | | | | | | | | | | | |
| Size (after cooking) cm | 8.4 | 8.5 | 8.7 | 8.6 | 8.7 | 8.9 | 8.8 | 8.7 | 8.6 | 8.4 | 8.6 | 8.6 |
| (horizontal) | | | | | | | | | | | | |
| Thickness (After cooking) | 1.4 | 1.4 | 1.4 | 1.5 | 1.4 | 1.4 | 1.6 | 1.6 | 1.7 | 1.5 | 1.5 | 1.5 |

TABLE 9
Trial #7 for Indicator Composition in NTF Hamburgers

| Hamburger | | 1 | 2 | 3 | 4 | 5 | 6 | 7 | 8 | 9 | 10 | 11 | 12 |
|---|---|---|---|---|---|---|---|---|---|---|---|---|---|
| Size (Before cooking) cm | | 10.7 | 10.9 | 10.8 | 11.3 | 11.3 | 11.1 | 11.2 | 11.2 | 11.3 | 11.2 | 10.8 | 11.0 |
| (horizontal) | | | | | | | | | | | | | |
| Size (Before cooking) cm | | 10.5 | 10.9 | 11.2 | 10.5 | 10.3 | 10.5 | 10.8 | 11.2 | 11.3 | 10.9 | 10.8 | 10.8 |
| (vertical) | | | | | | | | | | | | | |
| Thickness (Before | | 1.5 | 1.5 | 1.5 | 1.5 | 1.4 | 1.4 | 1.3 | 1.4 | 1.4 | 1.4 | 1.5 | 1.5 |
| cooking) | | | | | | | | | | | | | |
| Temperature (Before | | 16.3 | 17.4 | 6.1 | 19.2 | 19.2 | 19.8 | 15.0 | 19.7 | 17.8 | 15.6 | 14.9 | 16.1 |
| cooking) | | | | | | | | | | | | | |
| 1 | min | 19.8 | 19.9 | 18.1 | 20.3 | 31.3 | 22.6 | 25.6 | 26.1 | 26.6 | 17.5 | 17.2 | 16.7 |
| 2 | min (flip) | 30.8 | 28.4 | 23.1 | 24.2 | 24.2 | 25.0 | 24.9 | 25.6 | 23.5 | 19.9 | 20.1 | 19.4 |
| 3 | min | 26.4 | 32.4 | 36.2 | 33.7 | 35.5 | 36.8 | 38.2 | 40.1 | 40.5 | 28.6 | 29.0 | 29.4 |
| 4 | min (flip) | 43.7 | 45.1 | 41.5 | 50.2 | 49.2 | 47.5 | 50.0 | 49.6 | 44.8 | 32.5 | 31.9 | 30.6 |
| 5 | min | 49.5 | 48.4 | 45.9 | 58.5 | 58.3 | 57.7 | 48.9 | 50.6 | 51.1 | 35.2 | 35.6 | 37.0 |
| 6 | min (flip) | 53.2 | 54.4 | 54.6 | 65.5 | 64.4 | 62.3 | 59.7 | 58.0 | 57.7 | 43.4 | 43.6 | 44.1 |
| 7 | min | 67.3 | 61.9 | 58.5 | 58.1 | 60.5 | 62.7 | 65.7 | 65.8 | 66.3 | 47.6 | 49.9 | 51.9 |
| 8 | min (flip) | 64.2 | 65.3 | 64.5 | 68.4 | 68.9 | 70.3 | 66.1 | 67.1 | 67.6 | 53.6 | 52.5 | 54.5 |
| 9 | min | 70.7 | 65.3 | 62.9 | 70.4 | 71.0 | 68.1 | 69.5 | 66.5 | 64.1 | 55.0 | 58.3 | 62.6 |
| 10 | min (flip) | | 70.3 | 70.5 | | | 70.7 | | 70.4 | 71.8 | 63.9 | 64.0 | 64.9 |
| 11 | min | | | | | | | | | | 70.5 | 69.4 | 70.4 |

| | | | | | | | | | | | | |
|---|---|---|---|---|---|---|---|---|---|---|---|---|
| Size (after cooking) | 8.7 | 9.0 | 9.0 | 9.3 | 9.6 | 9.6 | 9.4 | 9.3 | 9.2 | 9.2 | 8.9 | 9.5 |
| (horizontal) | | | | | | | | | | | | |
| Size (after cooking) cm | 8.9 | 8.8 | 8.8 | 8.5 | 8.4 | 8.6 | 8.5 | 8.4 | 8.9 | 8.5 | 8.7 | 8.5 |
| (horizontal) | | | | | | | | | | | | |
| Thickness (After cooking) | 1.6 | 1.5 | 1.6 | 1.5 | 1.6 | 1.5 | 1.5 | 1.6 | 1.6 | 1.6 | 1.6 | 1.7 |

TABLE 10
Trial #8 for Indicator Composition in NTF Hamburgers

| Hamburger | | 13 | 14 | 15 | 16 | 17 | 18 | 19 | 20 | 21 | 22 | 23 | 24 |
|---|---|---|---|---|---|---|---|---|---|---|---|---|---|
| Size (Before cooking) cm | | 11.0 | 11.1 | 11.1 | 11.1 | 10.9 | 10.9 | 11.0 | 11.2 | 10.9 | 11.0 | 10.9 | 10.9 |
| (horizontal) | | | | | | | | | | | | | |
| Size (Before cooking) cm | | 11.0 | 10.8 | 10.8 | 10.8 | 11.0 | 10.7 | 11.0 | 11.0 | 11.1 | 10.8 | 11.2 | 11.2 |
| (vertical) | | | | | | | | | | | | | |
| Thickness (Before | | 1.5 | 1.6 | 1.5 | 1.5 | 1.5 | 1.4 | 1.4 | 1.4 | 1.4 | 1.6 | 1.6 | 1.5 |
| cooking) | | | | | | | | | | | | | |
| Temperature (Before | | 16.4 | 14.5 | 12.0 | 17.5 | 13.0 | 13.3 | 15.6 | 14.3 | 14.1 | 17.2 | 16.6 | 16.3 |
| cooking) | | | | | | | | | | | | | |
| 1 | min | 23.1 | 24.1 | 20.4 | 21.2 | 21.2 | 20.7 | 19.0 | 19.2 | 20.3 | 19.1 | 19.1 | 19.4 |
| 2 | min | 27.8 | 28.1 | 29.6 | 20.8 | 21.1 | 20.6 | 34.9 | 34.7 | 31.6 | 31.4 | 31.6 | 29.6 |
| 3 | min | 37.2 | 37.7 | 40.6 | 31.7 | 32.8 | 35.2 | 38.6 | 38.7 | 39.1 | 38.8 | 38.9 | 39.3 |
| 4 | min (flip) | 45.5 | 45.2 | 44.8 | 45.2 | 44.7 | 43.6 | 53.3 | 52.9 | 48.7 | 48.0 | 47.2 | 44.5 |
| 5 | min | 52.8 | 52.2 | 55.9 | 51.1 | 51.1 | 50.4 | 56.6 | 56.5 | 55.3 | 51.2 | 50.8 | 49.9 |
| 6 | min (flip) | 60.4 | 60.3 | 61.2 | 55.1 | 53.4 | 52.4 | 57.8 | 57.3 | 58.4 | 53.9 | 53.8 | 54.6 |
| 7 | min | 67.8 | 67.4 | 67.8 | 60.9 | 61.6 | 60.6 | 64.3 | 64.7 | 65.3 | 59.0 | 54.1 | 50.9 |
| 8 | min (flip) | 66.1 | 67.4 | 68.6 | 58.8 | 64.5 | 57.5 | 66.6 | 66.4 | 66.4 | 66.4 | 66.7 | 66.8 |
| 9 | min | 70.5 | 69.2 | 69.2 | 65.4 | 61.4 | 61.1 | 68.4 | 67.7 | 70.6 | 69.6 | 70.3 | 70.5 |
| 10 | min (flip) | | | 70.5 | 70.9 | 65.7 | 67.6 | 69.0 | 69.4 | | | 70.3 | |
| 11 | min | | | | | 71.2 | 70.8 | | | | | 69.8 | |

| | | | | | | | | | | | | |
|---|---|---|---|---|---|---|---|---|---|---|---|---|
| Size (after cooking) | 9.1 | 9.2 | 8.8 | 9.0 | 9.3 | 9.3 | 9.2 | 9.0 | 9.0 | 9.1 | 8.9 | 9.0 |
| (horizontal) | | | | | | | | | | | | |
| Size (after cooking) cm | 8.2 | 8.3 | 8.7 | 8.2 | 8.6 | 8.6 | 8.7 | 8.6 | 8.8 | 8.5 | 8.6 | 8.6 |
| (horizontal) | | | | | | | | | | | | |
| Thickness (After cooking) | 1.5 | 1.6 | 1.6 | 1.5 | 1.6 | 1.7 | 1.6 | 1.6 | 1.4 | 1.5 | 1.5 | 1.5 |

TABLE 11
Trial for Indicator Composition in Standard Fill Hamburgers

| Hamburger | | 1 | 2 | 3 | 4 | 5 | 6 | 7 | 8 | 9 | 10 | 11 | 12 |
|---|---|---|---|---|---|---|---|---|---|---|---|---|---|
| Size (Before cooking) cm | | 11.6 | 11.8 | 11.7 | 11.7 | 11.8 | 11.8 | 11.8 | 11.8 | 11.8 | 11.8 | 11.6 | 11.8 |
| (horizontal) | | | | | | | | | | | | | |
| Size (Before cooking) cm | | 11.7 | 11.7 | 11.7 | 11.6 | 11.7 | 11.8 | 11.8 | 11.7 | 11.8 | 11.7 | 11.7 | 11.8 |
| (vertical) | | | | | | | | | | | | | |
| Thickness (Before | | 1.4 | 1.3 | 1.4 | 1.4 | 1.3 | 1.3 | 1.4 | 1.4 | 1.3 | 1.4 | 1.4 | 1.4 |
| cooking) | | | | | | | | | | | | | |
| Temperature (Before | | 14.9 | 6.2 | 11.1 | 25.5 | 25.2 | 24.3 | 17.6 | 18.4 | 18.5 | 21.2 | 20.6 | 20.8 |
| cooking) | | | | | | | | | | | | | |
| 1 | min | 16.1 | 11.7 | 14.0 | 25.7 | 25.4 | 27.4 | 21.2 | 20.6 | 20.0 | 24.4 | 25.0 | 26.1 |
| 2 | min (flip) | 20.3 | 19.1 | 15.8 | 37.2 | 38.3 | 36.4 | 32.4 | 32.9 | 35.0 | 36.7 | 36.8 | 34.8 |
| 3 | min | 19.6 | 20.2 | 20.1 | 43.2 | 44.2 | 50.4 | 43.0 | 44.9 | 45.9 | 47.1 | 45.6 | 45.2 |
| 4 | min (flip) | 25.5 | 25.3 | 25.4 | 52.2 | 51.8 | 52.8 | 45.3 | 46.3 | 46.0 | 50.0 | 47.0 | 47.3 |
| 5 | min | 31.9 | 32.7 | 34.7 | 54.0 | 54.9 | 57.7 | 54.7 | 55.7 | 58.5 | 57.0 | 59.0 | 58.4 |
| 6 | min (flip) | 39.5 | 39.1 | 38.7 | 55.9 | 56.7 | 58.4 | 58.0 | 56.9 | 57.9 | 59.0 | 63.4 | 61.0 |
| 7 | min | 50.3 | 48.3 | 45.7 | 65.1 | 65.2 | 67.1 | 65.6 | 64.8 | 65.8 | 63.5 | 66.1 | 66.5 |
| 8 | min (flip) | 53.0 | 52.2 | 50.7 | 66.8 | 65.7 | 67.2 | 67.4 | 64.6 | 66.0 | 69.9 | 68.3 | 67.6 |
| 9 | min | 56.7 | 56.0 | 54.2 | | | | | | | | | |
| 10 | min (flip) | 59.1 | 58.2 | 58.7 | | | | | | | | | |
| 11 | min | 61.4 | 59.3 | 59.2 | | | | | | | | | |
| 12 | min | 68.9 | 69.8 | 65.4 | | | | | | | | | |

| | | | | | | | | | | | | |
|---|---|---|---|---|---|---|---|---|---|---|---|---|
| Size (after cooking) | 9.8 | 10.0 | 9.8 | 9.8 | 9.3 | 8.9 | 9.4 | 9.8 | 9.6 | 9.5 | 9.5 | 9.7 |
| (horizontal) | | | | | | | | | | | | |
| Size (after cooking) cm | 8.5 | 8.3 | 8.7 | 8.4 | 8.2 | 8.4 | 8.4 | 8.4 | 8.4 | 8.6 | 8.3 | 8.6 |
| horizontal) | | | | | | | | | | | | |
| Thickness (After cooking) | 1.7 | 1.7 | 1.7 | 1.8 | 1.7 | 1.9 | 1.9 | 1.7 | 1.7 | 1.9 | 1.7 | 1.8 |

TABLE 12
Trial for Indicator Composition in Standard Fill Hamburger

| Hamburger | | 13 | 14 | 15 | 16 | 17 | 18 | 19 | 20 |
|---|---|---|---|---|---|---|---|---|---|
| Size (Before cooking) | | 11.8 | 11.8 | 11.8 | 11.8 | 11.9 | 11.8 | 11.9 | 11.8 |
| cm (horizontal) | | | | | | | | | |
| Size (Before cooking) cm | | 11.7 | 11.8 | 11.7 | 11.7 | 11.7 | 11.7 | 11.7 | 11.8 |
| (vertical) | | | | | | | | | |
| Thickness (Before | | 1.4 | 1.4 | 1.4 | 1.4 | 1.3 | 1.4 | 1.4 | 1.4 |
| cooking) | | | | | | | | | |
| Temperature (Before | | 23.0 | 20.1 | 18.2 | 26.1 | 27.3 | 22.8 | 24.3 | 21.2 |
| cooking) | | | | | | | | | |
| 1 | min | 24.2 | 22.0 | 22.5 | 43.7 | 44.4 | 48.6 | 23.8 | 23.7 |
| 2 | min (flip) | 28.7 | 27.7 | 27.8 | 46.7 | 42.7 | 44.4 | 38.4 | 39.3 |
| 3 | min | 43.9 | 44.3 | 44.7 | 45.3 | 44.7 | 48.0 | 49.4 | 49.9 |
| 4 | min (flip) | 47.4 | 47.2 | 48.1 | 49.6 | 49.7 | 52.1 | 50.9 | 51.0 |
| 5 | min | 56.6 | 58.4 | 60.6 | 57.6 | 58.0 | 60.2 | 58.8 | 59.5 |
| 6 | min (flip) | 59.0 | 58.5 | 58.9 | 60.1 | 63.2 | 64.4 | 61.4 | 60.3 |
| 7 | min | 62.5 | 62.3 | 62.7 | 66.4 | 64.9 | 64.7 | 68.6 | 69.7 |
| 8 | min (flip) | 68.9 | 69.8 | 70.4 | 68.2 | 65.5 | 68.3 | | |
| 9 | min | | | | 69.8 | | | | |

| | | | | | | | | |
|---|---|---|---|---|---|---|---|---|
| Size (after cooking) | 9.7 | 9.8 | 10.0 | 10.0 | 9.0 | 9.9 | 9.7 | 9.9 |
| (horizontal) | | | | | | | | |
| Size (after cooking) cm | 8.2 | 8.2 | 8.5 | 8.6 | 8.5 | 8.4 | 8.5 | 8.5 |
| (horizontal) | | | | | | | | |
| Thickness (After cooking) | 2.0 | 1.7 | 1.8 | 1.6 | 1.6 | 1.7 | 1.7 | 1.7 |

### REFERENCES

Aberle, E. D., Forrest, J. C., Gerrard, D. E., & Mills, E. W. (2001). Principles of meat science. 4^{th} Edition.Kendall/Hunt Publishing Co., Dubuque, Iowa.
AOCS. (2009). Official Methods and Recommended Practices of the American Oil Chemists' Society, 5th ed.; American Oil Chemists' Society: Champaign, Ill., Cc 3-25; Cc 1-25.
Kerry, J. P., O'Grady, M. N., & Hogan, S. A. (2006). Past, current and potential utilisation of active and intelligent packaging systems for meat and muscle-based products: A review. Meat Science 74, 113-130
King, N. J., & Whyte, R. (2006). Does it look cooked? A review of factors that influence cooked meat color. Journal of Food Science, 71(4), R31-R40.
Killinger, K. M., Hunt, M. C., Campbell, R. E., & Kropf, D. H. (2000). Factors affecting premature browning during cooking of store-purchased ground beef. Journal of Food Science, 65(4), 585-587.
Kiranmaryi, C. B., Krishnaiah, N., & Mallika, E. N. (2010). Escherichia coliO157:H7—An emerging pathogen in foods of animal origin. Veterinary World, 3(8), 382-389.
Lee, S. Y., Hillers, V. N., McCurdy, S. M. & Kang, D. H. (2004). Comparison of cleaning methods for reduction of attached microorganisms from consumer-style thermometers. Journal of Rapid Methods and Automation in Microbiology, 12, 225-233.
McCurdy, S. M., Mayes, E., Hillers, V. N., Kang, D. H., & Edlefsen, M. S. (2004). Availability, accuracy and response time of instant read food thermometers for consumer use, Food Protection Trends, 24. 961-968
Mancini, R. A., Kropf, D. H., Hunt, M. C., & Johnson, D. E. (2005). Effects of endpoint temperature, pH, and storage time on cooked internal color reversion of pork longissimus chops. Journal of Muscle Foods, 16, 16-26.
Nuin, M., Alfaro, B., Cruz, Z., Argarate, N., George, S., Marc, Y. L., Olley, J., & Pin, C. (2008). Modelling spoilage of fresh turbot and evaluation of a time—temperature integrator (TTI) label under fluctuating temperature. International Journal of Food Microbiology, 127, 193-199.
Prodromidis, I. M., & Karayannis, I. M. (2002). Enzyme based amperometric biosensors for food analysis. Electroanalysis, 14(4), 241-261.
Seyfert, M., Mancini, R. A., & Hunt, M. C. (2004). Internal premature browning in cooked ground beef patties from high-oxygen modified-atmosphere packaging. Journal of Food Science, 69(9), 721-725.
Tsironi, T., Gogou, E., Velliou, E., & Taoukis, P. S. (2008). Application and validation of the TTI based chill chain management system SMAS (Safety Monitoring and Assurance System) on shelf life optimization of vacuum packed chilled tuna. International Journal of Food Microbiology, 128, 108-115.

All publications and patent (U.S. Pat. No. 6,607,744) applications/patents mentioned in this specification are herein incorporated by reference in their entirety to the same extent as if each individual publication or patent or patent application was specifically and individually indicated to be incorporated by reference.

The invention is described herein and it is apparent to one of skill in the art that many changes and modifications can be made thereto without departing from the scope of the appended claims.

1. An edible, temperature-sensitive, lipid-based composition that irreversibly undergoes a clear and visible physical transition change within a sharp melting point that indicates the doneness of a food product in which it is contained, wherein doneness indicates that harmful pathogens are essentially inactivated in the food product and the food product is thus safe to consume, and wherein said temperature range is selected from the group consisting of about 65° C. to about 80° C.; 65° C. to about 80° C.; 70° C. to about 80° C.; 65° C. to about 75° C.; 65° C. to about 70° C.; and 75° C. to about 80° C.

2. (canceled)

3. (canceled)

4. (canceled)

5. (canceled)

6. The composition of claim 1, wherein said harmful pathogen is selected from the group consisting of E. coli O157:H7, Listeria monocytogenes, Salmonella, Shigella, Vibrio, trichinosis and combinations thereof.

7. The composition of claim 1, wherein doneness indicates a desired degree of doneness that the food product has been cooked to a desired degree selected from rare, medium rare, medium, medium well or well done, and wherein said sharp melting point occurs at a temperature range of from about 50° C. to about 100° C.

8. (canceled)

9. The composition of claim 7, wherein the temperature range is selected from the group consisting of:
(a) for rare, about 52° C.-55° C.,
(b) for medium rare, about 55° C.-60° C.,
(c) for medium, about 60° C. to about 65° C.,
(d) for medium well, about 65° C. to about 69° C. and
(e) for well done, about 71° C. to about 100° C.

10. The composition of claim 1, wherein said food product is selected from the group consisting of:
(a) whole and/or ground meat selected from the group consisting of beef, pork, goat, bison, lamb, rabbit and combinations thereof,
(b) whole and/or ground poultry selected from the group consisting of chicken, duck, turkey, pheasant, partridge and combinations thereof; and
(c) an egg containing food product that is raw or partially cooked.

11. (canceled)

12. (canceled)

13. The composition of claim 1, wherein said lipid is a fatty acid selected from the group consisting of palm fat, stearic fatty acid, arachidic acid, hydrogenated soybean oil, canola stearin and combinations thereof, wherein said lipid is a glyceride selected from the group consisting of a triacylglyceride, a diacylglyceride and combinations thereof.

14. (canceled)

15. The composition of claim 1 further comprising a temperature modifier and an optional color indicator, selected from the group consisting of natural food dyes, synthetic dyes and phytochemicals.

16. The composition of claim 15, wherein said temperature modifier is present in an amount of up to about 20% by weight or about 1% to 10% by weight and is selected from the group consisting of thickening stabilizing and emulsifying agents.

17. The composition of claim 7, wherein said temperature modifier is a carbohydrate selected from the group consisting of carboxymethyl cellulose (CMC), carrageenans, alginate and combinations thereof.

18. The composition of claim 15, wherein said temperature modifier is a protein selected from the group consisting of plant and animal proteins, and said protein is selected from the group consisting of a canola protein isolate, a soy protein, a whey protein and a milk protein.

19. (canceled)

20. (canceled)

21. (canceled)

22. The composition of claim 15, wherein said phytochemical is selected from the group consisting of lutein, lycopene and saffron.

23. The composition of claim 1 provided as a discrete unit having a diameter of at least about 0.5 mm, and wherein said discrete unit is maintained at a temperature range of about 4° C. to below freezing.

24. (canceled)

25. The composition of claim 1, wherein said composition is provided in an uncooked ground meat food product, an uncooked ground/chopped vegetable food product, an uncooked ground fish food product or a raw egg containing food product.

26. (canceled)

27. (canceled)

28. An uncooked vegetable, fish or meat patty comprising one or more discrete units of an edible temperature sensitive composition that upon cooking and reaching a temperature range of about 60° C. to 80° C., the composition comprising:
lipid having a melting point of from about 60° C. to about 80° C.;
about 1% to about 10% by weight temperature modifier; and
optionally about 0.1% to about 5% by weight colour indicator.
wherein the composition irreversibly undergoes a clear and visible physical transition change that indicates the doneness of a food product in which it is contained, and wherein said discrete units melt and form a hole once reaching said temperature range.

29. (canceled)

30. (canceled)

31. (canceled)

32. (canceled)

33. (canceled)

34. (canceled)

35. (canceled)

36. (canceled)

37. A method to indicate the doneness of hamburger or veggie patty:
inserting into an uncooked hamburger or veggie patty one or more discrete units of a composition comprising an edible lipid based temperature sensitive composition of claim 1;
applying a heat source to the hamburger or veggie patty; and
observing a clear and irreversible physical transition of said discrete units,
wherein said physical transition indicates that the internal temperature of the hamburger or veggie patty is about 65° C. to 75° C. indicating that any harmful pathogens are essentially inactivated.

38. The method of claim 37, wherein said lipid is canola stearin, and wherein said composition further comprises up to about 20% by weight modifier, and about 0.01% to about 5% by weight color indicator.

39. (canceled)

40. (canceled)

41. (canceled)

42. (canceled)

43. (canceled)

44. (canceled)

45. A method of making an edible temperature sensitive composition, the method comprising:
(a) blending a lipid having a melt profile of about 50° C. to about 100° C. with about 1% to 20% by weight temperature modifier and optionally 0.01% to 5% by weight colour indicator at about room temperature;
(b) melting (a) just above the melting temperature to form a homogenously dispersed solution;
(c) cooling the homogeneously dispersed solution; and
(d) re-solidifying into discrete units.

46. The method of claim 45, wherein the lipid is canola stearin.

47. The method of claim 45, wherein the lipid has a melt profile of about 60° C. to about 80° C.

48. The composition of claim 1, wherein said composition essentially does not negatively affect the organoleptic properties of the food product in which it is integrated after cooking.

49. (canceled)

50. The composition of claim 25, wherein said uncooked ground meat food product is a raw hamburger comprising one or more discrete units comprised of the edible temperature sensitive lipid based composition comprising canola stearin, wherein said composition irreversibly undergoes a clear and visible physical transition change within a sharp melting point of about 69° C. to about 72° C. that indicates the doneness of the hamburger upon cooking.

51. The hamburger of claim 50, wherein upon reaching said sharp melting point indicates that E. coli O157:H7 is inactivated.

52. The hamburger of claim 50, wherein upon reaching said sharp melting point, the discrete units melt and form holes or indents in the hamburger where the units are located.

53. The hamburger of claim 50 wherein the composition further comprises a colour indicator that upon reaching said sharp melting point evokes a colour in the cooked hamburger to indicate that E. coli O157:H7 is inactivated.
